(19) United States
(12) Patent Application Publication
(10) Pub. No.: US 2015/0009340 A1
(43) Pub. Date: Jan. 8, 2015

(54) CHARACTERIZING A DOWNSTREAM PATH OF A CABLE NETWORK

(71) Applicant: JDS Uniphase Corporation, Milpitas, CA (US)

(72) Inventors: Daniel K. CHAPPELL, Greenwood, IN (US); Robert J. FLASK, New Palestine, IN (US); Ching-Chang LIAO, Fishers, IN (US)

(73) Assignee: JDS Uniphase Corporation, Milpitas, CA (US)

(21) Appl. No.: 14/322,991

(22) Filed: Jul. 3, 2014

Related U.S. Application Data
(60) Provisional application No. 61/842,592, filed on Jul. 3, 2013.

(51) Int. Cl. H04N 17/00; H04N 5/455

(52) U.S. Cl. CPC H04N 17/004; H04N 5/455
USPC 348/184

(57) ABSTRACT

Downstream channel parameters of a cable network are displayed in graphical form as a function of the channel number or center frequency. Such parameters, including digital channel demodulation parameters, may be plotted concurrently as frequency spectra, revealing frequency signatures of particular network impairments. Frequency spectra of MER, BER, IUC, carrier level, and in-band spectral response may be plotted concurrently in various combinations, providing a concise summary view of a condition of a downstream path at a particular location in the network.

### CROSS-REFERENCE TO RELATED APPLICATIONS

The present application claims priority from U.S. Provisional Patent Application No. 61/842,592, entitled “CATV Downstream Analyzer” filed Jul. 3, 2013, which is incorporated herein by reference in its entirety.

### TECHNICAL FIELD

The present invention relates to characterization of cable networks, and in particular to equipment and methods for characterization of a downstream signal path in a cable network.

### BACKGROUND

A cable network delivers services such as digital television, Internet, and Voice-over-IP (VoIP) phone connection. A cable network has a controlling center or “head end”, which controls video and data traffic in the network by generating or distributing video and data signals. The signals are delivered over a tree-like network of a broadband coaxial cable called “cable plant”. Digital television signals are broadcast from the headend to a trunk of the cable plant, and delivered to subscribers' homes connected to branches of the cable plant. In going from the headend to subscribers, the signals are split many times, and are attenuated in the process. Accordingly, a strong downstream broadcast signal is required, so that the signal level at the subscribers' premises is strong enough to be reliably detected. Upstream signals from the subscribers' homes carry phone and Internet traffic. The upstream signals propagate from the branches of the cable plant towards the headend of the network.

Upstream and downstream signals occupy separate frequency bands called upstream and downstream frequency bands. Downstream information channel signals co-propagate in the downstream frequency band, and upstream signals co-propagate in the upstream frequency band. The frequency separation of the upstream and the downstream signals allows bidirectional amplification of these signals, which propagate in a common cable in opposite directions. In the United States, the upstream spectral band typically spans from 5 MHz to 42 MHz, while the downstream spectral band typically spans from 50 MHz to 860 MHz.

The upstream and downstream signals are prone to impairments and interference. Oxidized connectors can act as electrical diodes distorting the downstream signals by generating frequency harmonics, which can negatively impact both upstream and downstream signal paths. Aging equipment, such as signal boosters and amplifiers, can also distort the signals and add harmonics and “ringing” at unwanted frequencies. Another source of impairments is external electrical interference, termed “ingress noise”. Despite electrical shielding of the cable, outside signals may find their way into, and become guided by the cable. Shielding punctures, especially at customers' premises, improper installation, interference from closely placed high-current electrical equipment, etc., all contribute to accumulation of ingress noise. Furthermore, a cable plant can act as a receiving radio antenna. Thanks to its large size, a cable plant can pick up signals from otherwise unlikely sources, such as aviation radars.

The impairment situation worsens as new customers are added to an existing cable network. The cable plant is extended by adding more splitters and connectors, amplifiers, and long runs of coaxial cable to new locations. When a cable plant is expanded, a probability of downstream and upstream signal impairments increases. Accordingly, growth of extent and functionality of cable based networks must be matched by a growing effort to assure quality of existing services via periodic testing and maintenance of the networks.

Due to multitude of signals and signal formats being used in a typical cable network, testing cable network performance includes measuring multiple characteristics such as a frequency spectrum of RF signals, an in-band frequency response and a group delay, and other characteristics. By way of example, Chappell in U.S. Pat. No. 6,961,370 discloses an apparatus for determining a frequency response of a cable plant. The apparatus of Chappell includes one or more testers each having a tuner, digital demodulation circuitry, and a controller that measures an absolute power level at the tester location for a particular channel and that measures a relative frequency response for the channel based on the tap weight coefficients from the digital demodulation circuitry. The absolute and relative measurements are combined and then recorded by each tester. The combined values of two or more testers are compared to determine the total frequency response of the communication system.

Cable network performance is also evaluated on higher logical levels of data transmission. For instance, to evaluate quality of digital TV signal transmission, number of tests can be performed. A technician travels to various locations of the cable plant, and at each location, uses a specially constructed and programmed digital tester to evaluate digital signal quality for each channel of interest. Measured are such parameters as carrier level or amplitude, modulation error ratio (MER), bit error rate (BER), ingress under carrier (IUC), and other parameters. The measurements are usually performed on channel-by-channel basis, each channel diagnostic data being summarized on a separate screen or data page viewed by the technician on the tester's visual display.

Interpretation of the data collected for the purpose of maintenance and troubleshooting a cable network has long been a challenge for field technicians, which are typically trained on the job, and often lack a fundamental knowledge of digital signal generation, propagation, and processing. To overcome this challenge, Pangrac et al. in US Patent Application Publication 2003/0134599 suggested using an electronic device configured as a digital assistant for a field technician. The digital assistant presents on its display a network-specific information, in combination with generic technical information to assist the technician to identify and resolve network problems. In essence, the digital assistant functions as an electronic reference and guide. The technician assistant application may further incorporate a design module that assists a field technician with creating a new network or network extension.

The complexity of the processes involved in data reception and processing, as well as the sheer amount of data, present a certain difficulty for a technician tasked with solving a particular technical problem in a short amount of time. Digital references and guides of the prior art cannot replace an analytical step of selecting a most likely impairment of the network. Interpreting the diagnostic data requires analytical skills and knowledge of technology that field technicians are simply not trained or educated for. Accordingly, there is a significant value in presenting cable network test data in a simple and easy to understand format.

### SUMMARY

It is a goal of the invention to overcome many of the above mentioned problems and deficiencies of the prior art.

The inventors have realized that many cable network impairments have a unique frequency signature. As a result, impairments of digital data transmission impact frequency channels in a manner that often shows a recognizable pattern when presented as a frequency spectrum. Therefore, if the frequency dependence of various channel parameters, for example MER, BER, IUC of downstream channels, is presented as a frequency spectrum, the identification of impairments via visualization of various spectral features becomes easier. In other words, frequency spectra of MER, BER, IUC, and other higher-level parameters of downstream channels, when presented on a single screen of a testing device in a simple, clear, readable format, can facilitate cable network testing and troubleshooting by field technicians. Furthermore, combining these spectra on a single screen can provide a summary view of an overall “health” of a downstream signal path, allowing the technician to quickly evaluate a condition of a particular location of a cable network.

In accordance with an aspect of the invention, there is provided a method of characterizing a downstream path of a cable network, the downstream path including a plurality of downstream channels, each channel having a channel number or a center frequency, the method comprising:

(a) causing a tuner to tune in sequence to each one of the plurality of downstream channels;

(b) causing a processor to demodulate each one of the plurality of downstream channels and to determine a value of a first demodulation parameter of each one of the plurality of downstream channels tuned to in step (a); and

(c) causing a display to display the first demodulation parameter on a display in graphical form as a function of the channel number or center frequency.

In one exemplary embodiment, the plurality of downstream channels are consecutive channels spanning over a continuous frequency range, and in step (c), the first demodulation parameter is displayed as a first spectrum spanning over the frequency range. Preferably, the first parameter includes modulation error ratio (MER) or ingress under carrier (IUC).

In accordance with an aspect of the invention, there is further provided an apparatus for characterization of a downstream path of a cable network, the downstream path comprising a plurality of downstream channels within a downstream band, each channel having a channel number and/or a center frequency, the apparatus comprising:

a tuner configured to tune to a downstream channel, to provide a signal at an intermediate frequency;

a processor communicatively coupled to the tuner, configured to cause the tuner to tune in sequence to each one of the plurality of downstream channels; to modulate each one of the plurality of downstream channels; and to determine a value of a first demodulation parameter for each of the plurality of downstream channels tuned to by the tuner; and

a display communicatively coupled to the processor, configured to display the first demodulation parameter determined by the processor in graphical form as a function of the channel number or the center frequency.

In a preferred embodiment, the first demodulation parameter is selected from a group including MER and ingress under carrier. The processor can be further configured for determining, for each one of the plurality of downstream channels tuned to by the tuner, a value of a second parameter different from the first demodulation parameter, wherein the second parameter is selected from a group consisting of MER, BER, ingress under carrier, and carrier level. The display can be configured for displaying the second parameter concurrently with the first demodulation parameter in graphical form as a function of the channel number or the center frequency.

### BRIEF DESCRIPTION OF THE DRAWINGS

Exemplary embodiments will now be described in conjunction with the drawings, in which:

FIG. 1 illustrates a block diagram of an apparatus for characterization of a cable network downstream path according to the invention;

FIG. 2 illustrates a block diagram of a preferred embodiment of a demodulator of the apparatus of FIG. 1 according to the invention, including an FPGA accelerator coupled to an analog-to-digital converter (ADC);

FIG. 3 illustrates a flow chart of a method of characterization of a cable network downstream path according to the invention, using the apparatus of FIG. 1;

FIG. 4 illustrates an exemplary view of a display of the apparatus of FIG. 1, showing testing results for a continuous block of downstream channels of a cable network under test;

FIG. 5 illustrates an exemplary view of a display of the apparatus of FIG. 1, showing detailed test results for a spectral band including a single frequency channel;

FIG. 6 illustrates an exemplary view of a display of the apparatus of FIG. 1, showing detailed test results for a spectral band including two consecutive channels; and

FIG. 7 illustrates an exemplary view of a display of the apparatus of FIG. 1, showing downstream spectra of channel power, ingress under carrier, and BER, for the entire downstream band of a cable network.

### DETAILED DESCRIPTION

While the present teachings are described in conjunction with various embodiments and examples, it is not intended that the present teachings be limited to such embodiments. On the contrary, the present teachings encompass various alternatives and equivalents, as will be appreciated by those of skill in the art.

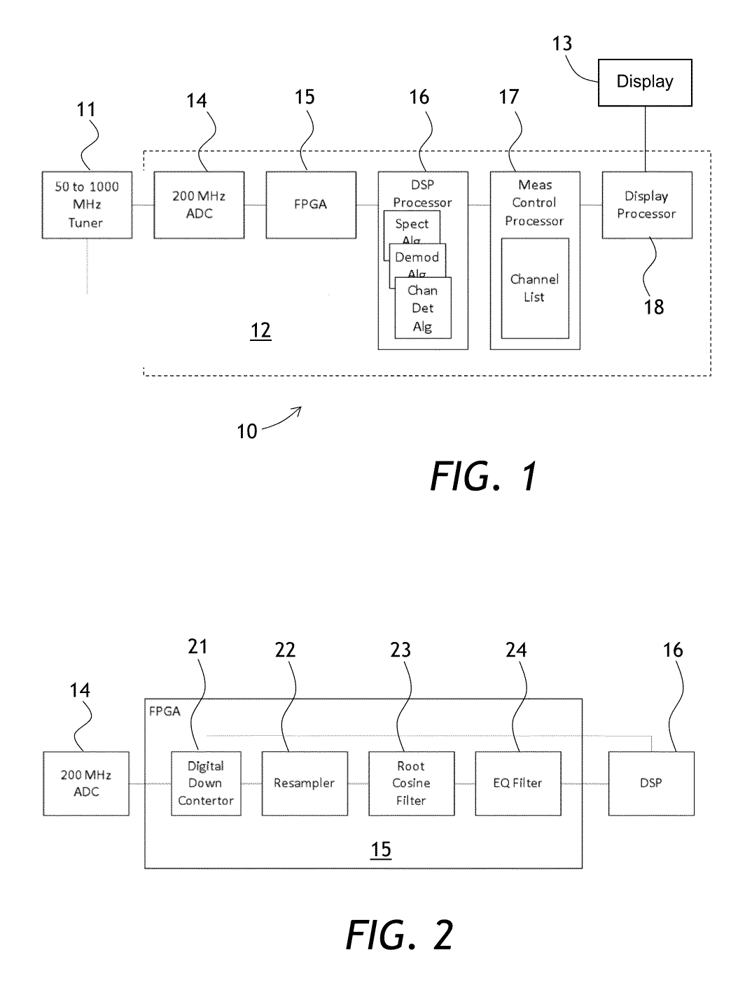

Referring to FIG. 1, an apparatus 10 of the invention for characterization of a downstream path of a cable network is shown. Generally, the apparatus 10 may include a tuner 11, a processor 12 coupled to the tuner 11, and a display 13 coupled to the processor 12. In operation, the tuner 11 tunes to a downstream channel of a plurality of downstream channels within a downstream transmission band of the cable network, to provide a signal at an intermediate frequency and supply the signal to the processor 12. The processor 12 may be configured to cause the tuner 11 to tune in sequence to each one of the plurality of downstream channels, to demodulate each one of the plurality of downstream channels, and to determine a value of a first demodulation parameter for each of the plurality of downstream channels tuned to by the tuner 11. The display 13 displays the first demodulation parameter determined by the processor in graphical form as a function of the channel number or the center frequency.

The tuner 11 may be configured to measure signal spectrum, and measure quadrature amplitude modulation (QAM) characteristics on a variety of downstream channels. The tuner 11 is capable of selecting a band of signals as wide as 8 MHz. Preferably, any signal that fits into a 8 MHz band may be processed by the tuner 11. The tuner 11 may be constructed to have a fast enough tuning time, e.g. 5 to 19 full range (1100 MHz) spectrum updates per second. The tuner 11 may maintain high enough signal fidelity that it can demodulate 256QAM signals. By way of a non-limiting example, the signal fidelity is such that the total phase error is less than 0.7 degrees in a 6 MHz bandwidth.

In the exemplary embodiment shown, the processor 12 may include an analog-to-digital converter (ADC) 14 coupled to the tuner 11, for digitizing the signal at the intermediate frequency for subsequent digital processing. Preferably, the ADC may have a dynamic range of at least 10.5 effective number of bits (ENOB). An FPGA accelerator 15 may be coupled to the ADC 14, for down-converting each of the plurality of downstream channels and for filtering the downconverted signal. A digital signal processing (DSP) processor 16 may be coupled to the FPGA accelerator 15. The DSP processor 16 and the FPGA accelerator 15 together may function as a demodulator. Other implementations of a demodulator are also possible, as known to persons of skill in the art.

The DSP processor 16 may be configured to cause the tuner 11 to tune in turn to each downstream channel and to determine a modulation scheme of that channel, according to techniques and methods known in the art. Once the modulation scheme is determined, the DSP processor 16 may demodulate the channel, and obtain demodulation parameters such as modulation depth, gain equalizer coefficients, and MER. Other channel parameters, such as a carrier level and in-band spectrum response, may be obtained, as will be explained below.

A measurement control processor 17 may be coupled to the DSP processor 16 for maintaining a list of channels and associated modulation parameters, and for controlling overall flow of measurements performed by the DSP processor 16, including the spectral measurements and demodulation processing. The spectral measurements generally have much idle DSP time, while the tuner 11 is settling to a new frequency. During this idle time of the DSP processor 16, the DSP processor 16 may either determine the channel type, or can demodulate signals.

Initially the measurement control processor 17 will go through a fixed list of possible downstream channels. The measurement control processor 17 may request the DSP processor 16 to determine the type of each channel, for example Analog Video (NTSC or PAL); Digital Video (Annex A, B or C); or “Unknown”. If the channel is Digital, the symbol rate and modulation depth is determined. The measurement control processor 17 may then instruct the DSP processor 16 to demodulate each of the detected channels sequentially. The first demodulation may take up to 0.5 seconds per channel, but many of the demodulation parameters are cached in order for the demodulation to be performed an order of magnitude faster in subsequent passes.

In addition to providing a list of tasks for the DSP processor 16 to perform, the measurement control processor 17 also gathers results from the DSP processor 16, and builds display data. A display processor 18 may be coupled to the measurement control processor 17 for receiving the display data from the measurement control processor 17 and generating pages of information to be displayed by the display 13, and for providing necessary user controls, for example, a frequency band or a list of downstream channels to process.

Turning to FIG. 2, the FPGA accelerator 15 may include a digital downconverter 21 for down-converting the signal at the intermediate frequency to provide a downconverted signal. A resampler 22 re-samples the downconverted signal, for example at 2× to 10× channel symbol rate, to provide a resampled signal. A root cosine filter 23 may be provided for filtering the resampled signal to match a modulation specified for the downstream channel being processed. An equalizing filter 24 may be used for removing linear distortions of the filtered signal.

Referring back to FIG. 1, the apparatus 10 may be implemented as a portable device usable in field conditions for cable network testing and troubleshooting, although a stationary implementation of the apparatus 10 is also possible.

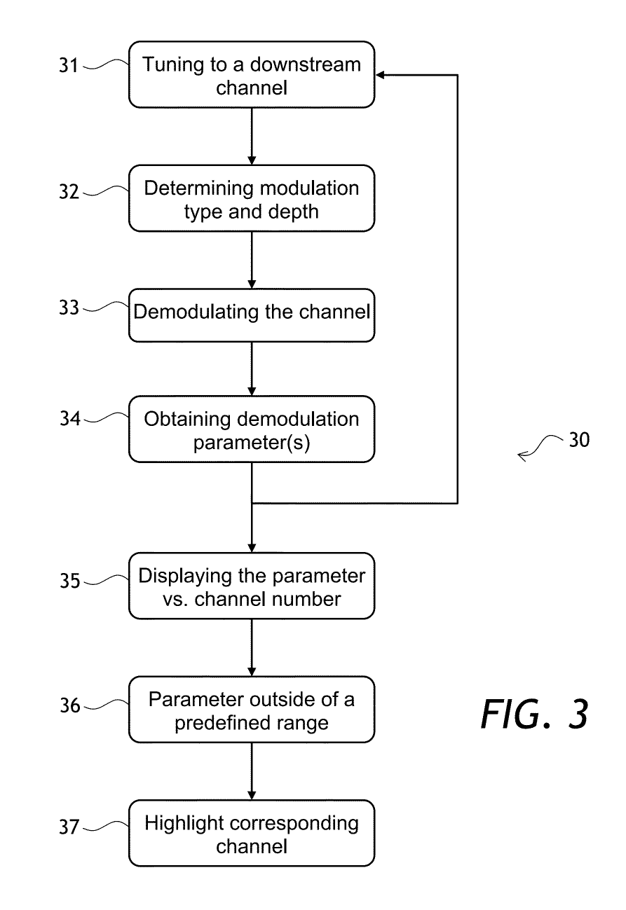

Referring now to FIG. 3 with further reference to FIG. 1, a method 30 (FIG. 3) of characterization of a downstream path of a cable network using the apparatus 10 of FIG. 1 is presented. The method 30 includes a step 31 of causing the tuner 11 (FIG. 1) to tune in sequence to each one of a plurality of downstream channels of the downstream path, and to perform subsequent steps for each channel. In a step 32, the measurement control processor 17 requests the DSP processor 16 to determine a modulation type and modulation depth of the channel tuned to. In a step 33, the channel is demodulated by the DSP processor 16. In a following step 34, demodulation parameters, such as MER or IUC, are determined by the DSP processor 16, for example modulation depth, gain equalizer coefficients, and MER. In this step, other parameters, that do not require demodulation, such as carrier level, can be determined in addition to, or instead of, the demodulation parameters. The tuning step 31, the parameter measuring step 34, and the optional demodulation related steps 32 and 33 may be repeated for other channels being evaluated. Then, in a step 35, the selected parameter, termed herein a “first demodulation parameter”, is displayed on the display 13 as a function of channel number, and/or a center frequency of each channel. Herein, the terms “first”, “second”, and the like do not denote an order in some sequence; rather, they are merely used as identifiers. More than one parameter can be displayed.

In following optional steps 36 and 37, the DSP processor 16 checks if the parameter is inside a pre-defined operational range for each channel. When the DSP processor 16 determines that the parameter is outside of the operational range for a certain channel, that channel is highlighted on the display 13 in the step 37, to warn a user that normal transmission on that channel is impaired.

Preferably, the plurality of downstream channels span consecutively over a continuous frequency range, termed a “first frequency range”. This may allow one to display the first demodulation parameter as a continuous “first spectrum” spanning over the first frequency range. This may also allow spectra of such parameters as MER and IUC to be obtained and displayed as spectra for diagnostic purposes. The IUC data may be calculated from error vectors of individual sequential symbols of a data packet, as disclosed by Tsui et al. in U.S. Pat. No. 6,385,237, incorporated herein by reference. Furthermore, spectra of decoding parameters and high-level transmission parameters, such as bit error ratio (BER), may also be obtained and displayed. In one embodiment, the first frequency range may span an entire downstream frequency band of the cable network.

Many cable network impairments have a unique frequency signature. As a result, impairments of digital data transmission may show a recognizable pattern when presented as a frequency spectrum. Frequency spectra of MER, BER, IUC, and other higher-level parameters of downstream channels, presented on the display 13, facilitate cable network testing and troubleshooting. Two or more different parameters may be concurrently displayed in graphical form, as a frequency spectrum on the display 13, thus providing a clear and concise summary of the state or “health” of the downstream path at the current test location. For instance, the first demodulation parameter may include MER or IUC, and the second parameter can include the other of MER or IUC, as well as BER and carrier level.

In addition to displaying carrier level, demodulation, and decoding parameters in form of frequency spectra, in-band channel functions, such as spectral response and channel spectrum, can be displayed as well. By way of non-limiting examples, the DSP processor 16 may obtain in-band spectral response and/or channel spectrum for each channel being tuned to in the tuning step 31. The in-band spectral response function of a channel may be determined by performing a fast Fourier transform (FFT) of demodulation equalization coefficients, that is, tap weight coefficients of the demodulator circuitry, as described by Chappell in U.S. Pat. No. 6,961,370, incorporated herein by reference. Individual response functions may then be concatenated into a continuous spectral response spanning across multiple digital channels. Similarly, the in-band channel spectrum may be calculated by performing an FFT of a time trace of a corresponding downconverted downstream channel, as known in the art. Once an in-band function is determined for each of the plurality of consecutive downstream channels tuned to in the tuning step 31, the in-band functions of different channels may be concatenated into a second spectrum and displayed concurrently with the first spectrum, that is, BER spectrum, MER spectrum, IUC spectrum, carrier spectrum, etc.

Referring back to FIG. 1, the measurement control processor 17 (FIG. 1) may be programmed for scanning consecutive channels spanning over a first frequency range. The display processor 18 may be configured for displaying the first demodulation parameter as a first spectrum spanning over the first frequency range, on the display 13. A significant portion, at least 30 consecutive channels, or at least 250 MHz of the downstream frequency band, maybe scanned, while performing demodulation according to steps 31 to 34 of the method 30 (FIG. 3). The measurement control processor 17 may be further configured for determining, for each one of the plurality of downstream channels tuned to by the tuner 11, a value of the second parameter different from the first demodulation parameter. The second parameter can be selected from MER, BER, IUC, and carrier level. When the plurality of downstream channels include consecutive channels, the measurement control processor 17 may be further configured for determining, for each one of the plurality of downstream channels tuned to by the tuner 11, a function selected from a group consisting of in-band spectral response and channel spectrum, and for concatenating the determined functions into a second spectrum; the display processor 18 can then be configured to display the second spectrum concurrently with the first demodulation parameter, so that the channel numbers are correlated with a frequency scale of the second spectrum.

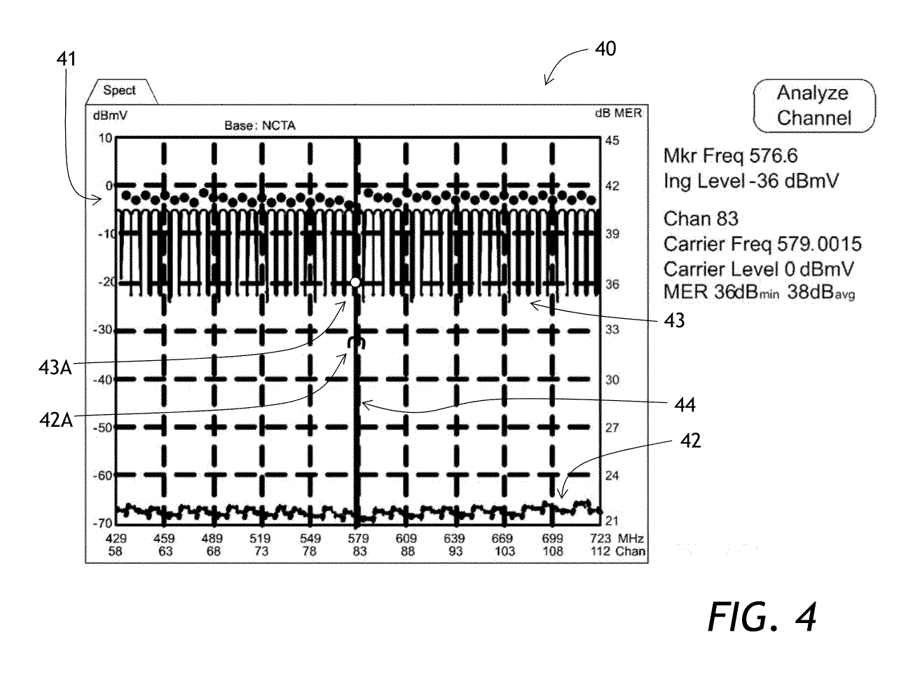

Referring to FIG. 4, an example downstream path test result summary screen 40 is illustrated. The tested downstream frequency band spans from 429 MHz to 723 MHz, which corresponds to, and correlates with, channel numbers #58 to #112.A plurality of solid round dots 41 corresponds to MER in dB units for each channel #58-112 (see right-hand scale in dB units). The IUC in dBmV is plotted at 42 (left-hand scale in dBmV units). In-band responses for each channel are shown at 43. In this example, channel #83 at 579 MHz is sub-optimal. Its MER, shown at 43A with a white circle, is 36 dB; and its IUC, shown at 42A with an bracket, is −36 dBmV. A marker bar 44 may be placed automatically onto the defective channel #83 to highlight the anomaly. Of course, anomalous results may be also selected in other ways known to a person skilled in the art. To find anomalies, the method 30 of FIG. 3 may include: the optional step 36 of determining that the first demodulation parameter (that is, MER or IUC) is outside of a pre-defined range for at least a first channel (that is, channel #83) of the plurality of downstream channels; and the optional step 37 of highlighting the first channel (that is, channel #83 in this example).

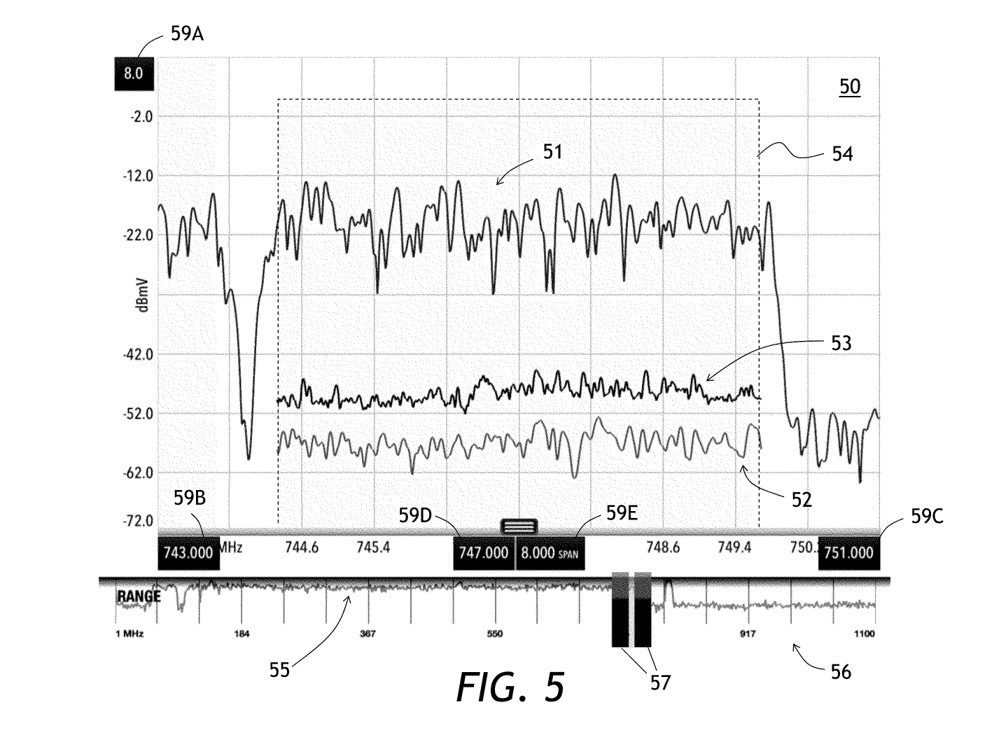

Turning to FIG. 5, an example single-channel analysis screen 50 of an actual measured downstream channel 54 centered at 747 MHz is shown. The screen 50 includes an in-band spectrum 51, an in-band IUC 52, and a maximum in-band IUC 53. An entire downstream signal spectrum 55 is shown in a bottom part 56 of the screen 50. The selected channel is denoted in the bottom part 56 with a pair of vertical bars 57. In the screen 50, the vertical scale denotes signal level in dBmV, the maximum vertical scale value being displayed at 59A. The horizontal scale denotes frequency and spans for 8 MHz. Minimum frequency, maximum frequency, center frequency, and frequency span are displayed at 59B, 59C, 59D, and 59E, respectively. The channel 54 is QAM256 modulated at a carrier level of 1.26 dBmV, average MER 38.97 dB, minimum MER 38.61 dB, Digital Quality Index (DQI) of 10.0, max. hum of 0.5%, and BER of 1.0E-9.

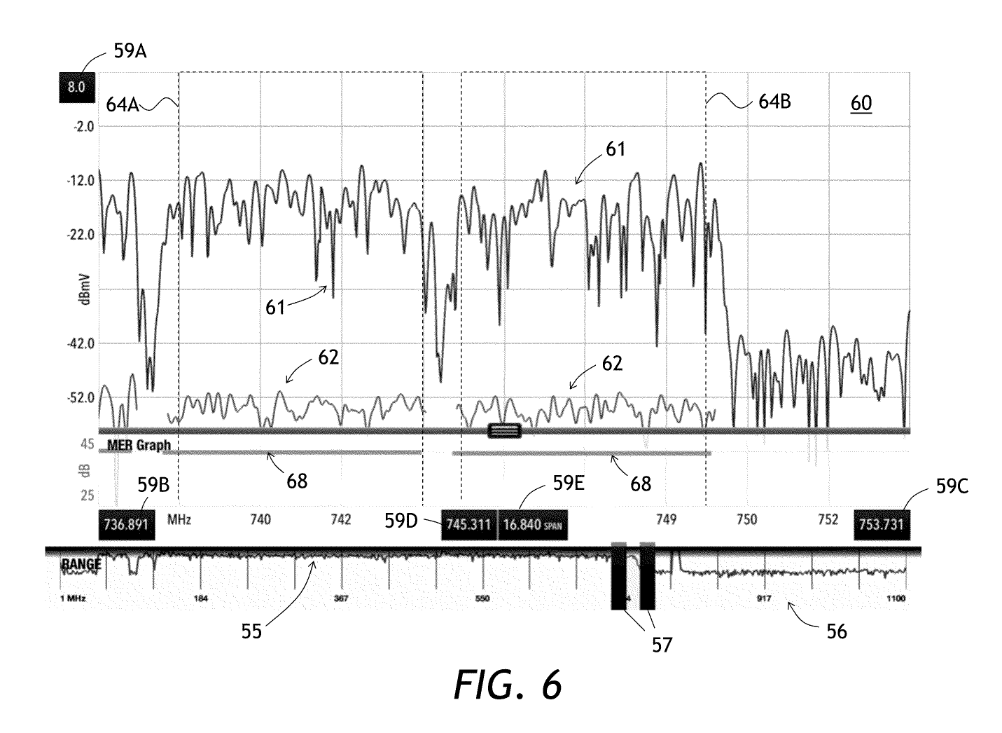

Referring to FIG. 6, a similar analysis screen 60 shows a frequency spectrum 61, an IUC 62, and MER 68 for neighboring channels 64A and 64B disposed in a frequency window of 16.84 MHz in width. Such information may be displayed for any part of the frequency spectrum. The selected frequency band of channels 64A and 64B is denoted in FIG. 6 in the bottom part 56 with the pair of vertical bars 57. In the screen 60, the vertical scale denotes signal level in dBmV. The horizontal scale denotes frequency in MHz. Minimum frequency, maximum frequency, center frequency, and frequency span are displayed at 59B, 59C, 59D, and 59E, respectively.

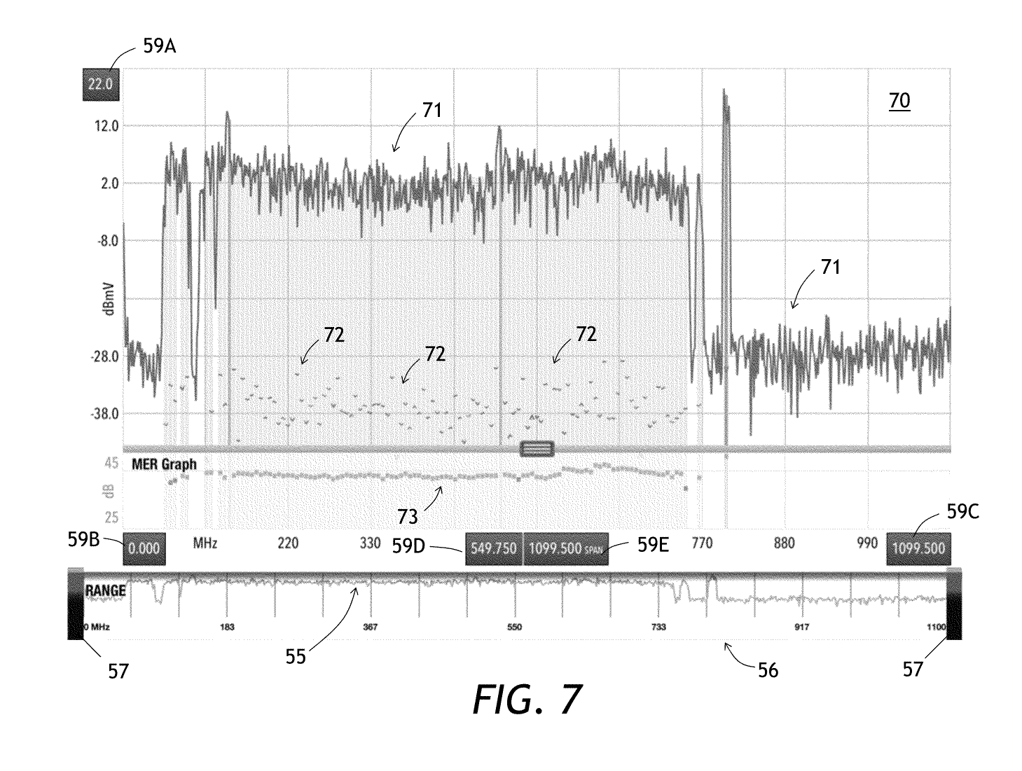

In this exemplary embodiment, automatic scanning of the entire frequency spectrum of a cable network may be enabled, with demodulation of each channel and displaying relevant demodulation parameters in spectral form, on a single screen page. Turning now to FIG. 7, a full-band analysis screen 70 shows a full-band frequency spectrum 71, IUC dots 72 for each channel, and a MER spectrum 73 for all downstream channels shown as grey bars under the spectrum 71. Similarly to FIGS. 5 and 6, the bottom part 56 of the full-band analysis screen 70 shows the full spectrum 55, and the vertical bars 57 denote the range of the spectrum on the top portion of the analysis screen 70. In the screen 70, the vertical scale denotes signal level in dBmV. The horizontal scale denotes frequency in MHz. Minimum frequency, maximum frequency, center frequency, and frequency span are displayed at 59B, 59C, 59D, and 59E, respectively.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method of characterizing a downstream path of a cable network, the downstream path including a plurality of downstream channels, each channel having a channel number or center frequency, the method comprising:
(a) causing a tuner to tune in sequence to each one of the plurality of downstream channels;
(b) causing a processor to demodulate each one of the plurality of downstream channels and to determine a value of a first demodulation parameter for each one of the plurality of downstream channels tuned to in step (a); and
(c) causing a display to display the first demodulation parameter on a display in graphical form as a function of the channel number or center frequency.

2. The method of claim 1, wherein the plurality of downstream channels are consecutive channels spanning over a first frequency range, wherein in step (c), the first demodulation parameter is displayed as a first spectrum spanning over the first frequency range.

3. The method of claim 2, the first frequency range spans an entire downstream frequency band of the cable network.

4. The method of claim 1, wherein the first demodulation parameter is selected from a group consisting of MER and ingress under carrier.

5. The method of claim 4, wherein the selected first demodulation parameter comprises the ingress under carrier calculated from a magnitude of a demodulation error.

6. The method of claim 4, wherein step (b) further comprises determining, for each of the plurality of downstream channels tuned to in step (a), a value of a second parameter different from the first demodulation parameter;
and wherein step (c) further comprises displaying the second parameter concurrently with the first demodulation parameter in graphical form as a function of the channel number or center frequency.

7. The method of claim 6, wherein the second parameter is selected from a group consisting of MER, BER, ingress under carrier, and carrier level.

8. The method of claim 2, wherein step (b) further includes determining, for each of the plurality of downstream channels tuned to in step (a), a function selected from a group consisting of in-band spectral response and channel spectrum, and
wherein step (c) further comprises concatenating the function into a second spectrum, and displaying the second spectrum concurrently with the first spectrum.

9. The method of claim 4, wherein the plurality of downstream channels of step (a) are consecutive channels,
wherein step (b) further comprises determining, for each of the plurality of downstream channels tuned to in step (a), a function selected from a group consisting of in-band spectral response and channel spectrum, and
wherein step (c) comprises concatenating the function into a second spectrum and displaying the second spectrum concurrently with the first demodulation parameter, wherein the channel number or central frequency of the first demodulation parameter are correlated with a frequency scale of the second spectrum.

10. The method of claim 4, wherein the in-band spectral response is calculated by performing an FFT of corresponding demodulation equalizer coefficients; and wherein the channel spectrum is calculated by performing an FFT of a corresponding downconverted downstream channel.

11. The method of claim 2, wherein the plurality of downstream channels comprises at least two consecutive channels, or wherein the first frequency range is at least 12 MHz.

12. The method of claim 11, wherein step (b) comprises demodulation of each one of the plurality of downstream channels, wherein the first demodulation parameter comprises ingress under carrier;
wherein step (b) further comprises determining, for each of the plurality of downstream channels tuned to in step (a), an in-band channel spectrum;
wherein step (c) comprises concatenating the in-band channel spectra of step (b) into a full signal spectrum and displaying the full signal spectrum concurrently with the ingress under carrier.

13. The method of claim 12, wherein step (b) further comprises determining MER for each of the plurality of downstream channels tuned to in step (a);
wherein step (c) comprises displaying the MER concurrently with the ingress under carrier, in graphical form as a function of the channel number or the center frequency.

14. The method of claim 1, further comprising
(d) causing the processor to determine that the first demodulation parameter is outside of a pre-defined range for at least a first channel of the plurality of downstream channels; and
(e) causing the processor to automatically highlight the first channel on the display.

15. An apparatus for characterization of a downstream path of a cable network, the downstream path comprising a plurality of downstream channels within a downstream band, each channel having a channel number and/or a center frequency, the apparatus comprising:
a tuner configured to tune to a downstream channel of the plurality of downstream channels, to provide a signal at an intermediate frequency;
a processor communicatively coupled to the tuner, configured: to cause the tuner to tune in sequence to each one of the plurality of downstream channels; to demodulate each one of the plurality of downstream channels; and to determine a value of a first demodulation parameter for each of the plurality of downstream channels tuned to by the tuner; and
a display communicatively coupled to the processor, configured to display the first demodulation parameter determined by the processor in graphical form as a function of the channel number or the center frequency.

16. The apparatus of claim 15, wherein the first demodulation parameter is selected from a group consisting of MER and ingress under carrier;
wherein the processor is further configured to determine, for each one of the plurality of downstream channels tuned to by the tuner, a value of a second parameter different from the first, wherein the second parameter is selected from a group consisting of MER, BER, ingress under carrier, and carrier level;
wherein the display is configured to display the second parameter concurrently with the first demodulation parameter, in graphical form as a function of the channel number or center frequency.

17. The apparatus of claim 15, wherein the plurality of downstream channels are consecutive channels spanning over a first frequency range, wherein apparatus is configured to display the first demodulation parameter as a first spectrum spanning over the first frequency range.

18. The apparatus of claim 15, wherein the plurality of downstream channels are consecutive channels,
wherein the processor is further configured to determine, for each one of the plurality of downstream channels tuned to by the tuner, a function selected from a group consisting of in-band spectral response and channel spectrum, and to concatenate the determined functions into a second spectrum; and
wherein the display is configured to display the second spectrum concurrently with the first demodulation parameter, wherein the channel numbers are correlated with a frequency scale of the second spectrum.

19. The apparatus of claim 15, wherein the tuner is configured to provide 5 to 19 full scans per second of the downstream band; and wherein the processor further comprises:
an ADC communicatively coupled to the tuner, configured to digitize the signal at the intermediate frequency, the ADC having a dynamic range of at least 10.5 effective number of bits; and
a demodulator communicatively coupled to the ADC, configured to demodulate each of the plurality of downstream channels.

20. The apparatus of claim 19, wherein the demodulator comprises an FPGA communicatively coupled to the ADC, the FPGA comprising coupled in series:
a digital downconverter for down-converting the signal at the intermediate frequency to provide a downconverted signal;
a resampler for resampling the downconverted signal at 2× to 10× channel symbol rate, to provide a resampled signal;
a root cosine filter for filtering the resampled signal to match a modulation specified for each channel, to provide a filtered signal; and
an equalizing filter for removing linear distortions of the filtered signal.
